(19) United States
(12) Patent Application Publication
(10) Pub. No.: US 2007/0012874 A1
(43) Pub. Date: Jan. 18, 2007

(54) Apparatus for and method of driving X-Y scanner in scanning probe microscope

(75) Inventors: Joonhui Kim, Seoul (KR); Sang-il Park, Sungnam (KR)

Correspondence Address: SILICON VALLEY PATENT GROUP LLP, 2350 MISSION COLLEGE BOULEVARD, SUITE 360, SANTA CLARA, CA, 95054, US

(73) Assignee: PSIA Corporation

(21) Appl. No.: 11/147,908

(22) Filed: Jun. 7, 2005

(51) Int. Cl. H01J 5/16

(52) U.S. Cl. 250/234

(57) ABSTRACT

Disclosed is an apparatus for driving an X-Y scanner in a scanning probe microscope. The apparatus includes one or more position detector for detecting a moved-position of a mobile stage and generating a moved-position signal. Thee mobile stage is capable of holding a specimen and moving along at least one of x-axis and y-axis from a reference position. A controller is provided for generating a plurality of control signals based on the moved-position signal from the position detector, such that the mobile stage is moved along at least one of x-axis and y-axis by a certain desired quantity of distance. Also, a plurality of drivers is provided for moving the mobile stage along at least one of x-axis and y-axis, in response to the control signals from the controller.

### BACKGROUND OF THE INVENTION

1. Field of the Invention

The present invention relates to an apparatus for and a method of driving an X-Y scanner in a scanning probe microscope. More specifically, the invention relates to an operation of X-Y scanner, in which plural drivers having different voltage-distance characteristics can be controlled such that a mobile stage can be moved in an identical and consistent manner.

2. Background of the Related Art

A scanning probe microscope (SPM) is used for examining a nano-scaled specimen or sample. In the SPM, while a pointed probe moves in a canning fashion above the specimen to be observed or examined, the surface contour and other physical properties thereof are observed and measured.

The scanning probe microscope includes a scanning tunnel microscope (STM), an atomic force microscopy (AFM), a near field scanning optical microscope (NSOM), a magnetic force microscope (MFM), or the like. An optical microscope has a limitation in its resolving power due to the diffraction of light, called a diffraction limitation. However, the scanning probe microscope has a high resolution, which is not achievable in the common-type optical microscopes. A contact-type scanning probe microscope may damage the surface of specimen due to contact of the probe with the surface. Thus, a non-contact scanning probe microscope has been proposed. In the non-contact scanning probe microscope, the probe is dithered with very small amplitude, and then the magnitude of the dithering is observed to thereby prevent the probe from touching the specimen. The amplitude of dithering probe is somewhat constant when the probe is far away from the specimen, but as the probe becomes closer to the specimen, the amplitude begins to become smaller. Right before the probe touches the specimen, the amplitude decrease noticeably and thus, the distance can be adjusted before the probe is collided with the specimen, thereby enabling a non-contact scanning probe microscope.

Recently, the scanning probe microscope having the above construction has come to employ two different scanners, which are separately mounted at different positions on a fixed frame. One of the scanners (or, called a “X-Y scanner”) scans a specimen on a plane (called a “X-Y plane”), and the other scanner (called a “Z scanner”) allows the probe to scan in a direction perpendicular to the X-Y plane (or, called “z direction), thereby enabling to image a large and heavy specimen such as a silicon wafer.

In case of the conventional X-Y scanner, if a small sized specimen is placed in the center of the scanner and scanned, a clear image can be provided, as shown in FIG. 13a. However, when a large specimen such as a silicon wafer is scanned, the acquired image becomes obscure particularly in the areas corresponding to the peripheral regions of the X-Y scanner, as shown in FIGS. 13b and 13c.

Accordingly, in case of a large sized sample such as the silicon wafer, the desired portion to be imaged must be moved into the central area of the conventional X-Y scanner.

In addition, in order for the corner of wafer to be moved into the center of the scanner, the size of the sample chuck, where the wafer is held, must be inevitably enlarged.

Furthermore, the X-Y scanner, which scans a sample on the X-Y plane, are provided with two drivers installed in parallel to each axis and using a stacked piezo. The stacked piezo is expanded 11.6 μm ideally, for example when a voltage of 100V is applied thereto. However, since the stacked piezo exhibits a displacement variation of about 2.0 μm, it expands in a range of 9.6˜13.6 μm.

In the above conventional scanner, if the two drivers installed at each axis do not have a balanced characteristic of voltage-distance, a clear image cannot be easily acquired, with respect to the peripheral area of sample.

Further, the conventional X-Y scanner is configured so as to control the scanner using two signals only of x-axis and y-axis. Thus, the expanded distance of each driver varies depending on the applied voltages, so that a parasitic motion such as tilting or rotation occurs in the peripheral area of sample, thereby failing to perform a precision control.

### SUMMARY OF THE INVENTION

Therefore, the present invention has been made in view of the above problems, and it is an object of the present invention to provide an apparatus for and a method of driving an X-Y scanner in a scanning probe microscope, in which the operation of an X-Y scanner is controlled such that a desired image for a specimen can be obtained, in particular, in the corner areas of the specimen.

To accomplish the above object, according to one aspect of the present invention, there is provided an apparatus for driving an X-Y scanner in a scanning probe microscope. The apparatus of the invention comprises: one or more position detector for detecting a moved-position of a mobile stage and generating a moved-position signal, the mobile stage capable of holding a specimen and moving along at least one of x-axis and y-axis from a reference position; a controller for generating a plurality of control signals based on the moved-position signal from the position detector, such that the mobile stage is moved along at least one of x-axis and y-axis by a certain desired quantity of distance; and a plurality of drivers for moving the mobile stage along at least one of x-axis and y-axis, in response to the control signals from the controller.

The driver may include a first driver for moving the mobile stage along the positive direction of x-axis; a second driver for moving the mobile stage along the negative direction of x-axis; a third driver for moving the mobile stage along the positive direction of y-axis; and a fourth driver for moving the mobile stage along the negative direction of y-axis.

In addition, the driver may comprise: a piezo expanding and contracting in response to the control signal from the controller; a pivot point making a point contact with the piezo; a force lever pivoting about the pivot point according to the expansion and contraction of the piezo; a spring for restoring the pivoted force lever to the original position thereof; and a driving jig for moving the mobile stage when the force lever is pivoted.

The controller may comprise: a voltage controller for detecting a current-position of mobile stage moved from the reference position using the moved-position signal from the position detector, and calculating a desired voltage value from the current-position voltage value such that the mobile stage can be moved to a desired position; and a voltage divider for dividing a voltage to be applied to each driver, according to the calculated voltage value from the voltage controller.

The voltage controller is configured such that, if the mobile stage is moved in a same quantity of distance in response to the control signal applied to each driver, the moving of mobile stage is ended.

The voltage divider may be a voltage distributor or a variable resistor.

The controller may comprise: a local feedback controller for detecting a current-position of mobile stage moved from the reference position using the moved-position signal from the position detector, and calculating a compensation value from the detected current-position such that the mobile stage can be moved to a desired position; and a voltage divider for dividing a voltage to be applied to each driver, according to the calculated compensation value from the local feedback controller.

The voltage divider may be a voltage distributor or a variable resistor.

The controller may comprise: a feedback controller for detecting a current-position of mobile stage moved from the reference position using the moved-position signal from the position detector, and calculating either a voltage value for the current-position voltage value or a compensation value from the detected current-position, or both of them, such that the mobile stage can be moved to a desired position; and a voltage divider for dividing a voltage to be applied to each driver, according to at least of the calculated voltage value and the calculated compensation value from the feedback controller.

The voltage divider may be a voltage distributor or a variable resistor.

According to another aspect of the invention, there is provided a method of driving an X-Y scanner in a scanning probe microscope. The method comprises steps of: (a) outputting a control signal for controlling a plurality of drivers such that a mobile stage can be moved along an x- and y-axis; (b) detecting a current-position signal of the mobile stage using a position detector for detecting a position of mobile stage; (c) analyzing the current-position signal from the position detector and determining whether the mobile stage is moved by a same quantity of distance from a reference position of each axis to a desired position along the positive or negative direction thereof; and (d) controlling as to whether or not each driver is to be operated, depending on the determination.

In the above step (c), if the mobile stage is not moved the same quantity of distance by the plurality of the driver, the method may further comprises a step of: dividing a voltage such that a control signal of a driver which has moved the mobile stage a longer distance can be decreased, and a control signal of a driver which has moved the mobile stage a shorter distance can be increased.

The control signal applied to the driver may include a voltage.

In the above step (c), if the mobile stage is not moved the same quantity of distance by the plurality of the driver, the method may further comprise a step of: applying a control signal such that the mobile stage can be moved from a reference position along the same axis to a desired position sequentially.

In the control signal applying step, the control signal may be obtained in accordance with the following equation.

$${V}_{x 1} = {\sum }_{t = 0}^{n} {a}^{i} {V}_{s}^{i}$$

Here, Vm is a voltage in a driver having a longer moving distance, n is a correction index, a is a value between 0.9 and 1, and Vs is a voltage in a driver having a shorter moving distance.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram illustrating the construction of an X-Y scanner in a scanning probe microscope (SPM) according to the invention;

FIG. 2 is an exploded perspective view showing the construction of an X-Y scanner in an SPM according to the invention;

FIG. 3 is an assembled rear view of the X-Y scanner of FIG. 2;

FIG. 4 is a plan view of the X-Y scanner of FIG. 2;

FIGS. 5a and 5b are sectional views of a scanner driver for moving the X-Y scanner of FIG. 2;

FIGS. 6a and 6b are schematic circuit diagrams showing a signal controller of the X-Y scanner in the SPM according to a first embodiment of the invention;

FIG. 7 is a flow chart explaining the control of a driver voltage using a variable resistor in the X-Y scanner according to the first embodiment of the invention;

FIGS. 8a and 8b are a schematic circuit diagram showing a local feedback unit of the X-Y scanner in the SPM according to a second embodiment of the invention;

FIGS. 9a to 9c are flow charts explaining the operation of the local feedback unit in FIGS. 8a and 8b;

FIGS. 10a to 10d are a schematic circuit diagram showing a local feedback unit of the X-Y scanner in the SPM according to a third embodiment of the invention;

FIG. 11 is flow chart explaining the operation of the local feedback unit in FIGS. 10a to 10d;

FIGS. 12a to 12c are photographs of a specimen placed in the center, right and left side of the X-Y scanner of the invention; and

FIGS. 13a to 13c are photographs of a specimen placed in the center, right and left side of a conventional X-Y scanner.

### DETAILED DESCRIPTION OF THE PREFERRED EMBODIMENT

The preferred embodiments of the invention will be hereafter described in detail, with reference to the accompanying drawings.

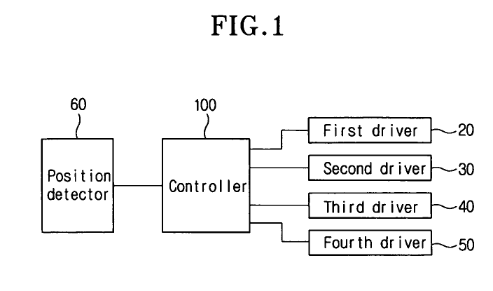

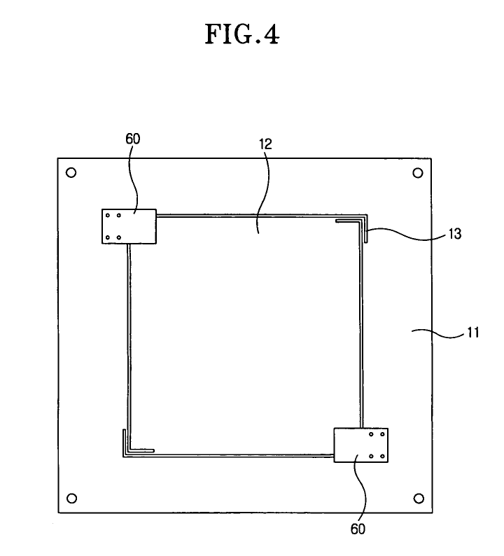

FIGS. 1 to 5 illustrate the construction of a X-Y scanner in a scanning probe microscope (SPM) according to the invention, where the X-Y scanner is denoted by reference number 10. Referring to FIGS. 1 to 5, the X-Y scanner 10 includes a X-Y scanner body 11, a mobile stage 12 for moving the position of a specimen, a bent leaf spring 13 for restoring the moved mobile stage 12 to its original position, a first driver 20, a second driver 30, a third driver 40, a fourth driver 50, a position detector 60 for detecting the position of the mobile stage 12, and a controller 100 for controlling the operation of the X-Y scanner 10.

The X-Y scanner body 11 has a rectangular shape. In the center of the X-Y scanner body is placed the mobile stage 12 cut out in a rectangular shape. The first to fourth drivers 20 to 50 are fixed in the bottom face of the X-Y scanner body 11.

The mobile stage 12 is disposed in the center of the scanner body 11 and has a sample chuck (not shown) for placing a specimen to be probed or examined. The position of the specimen on the sample chuck is displaced by the mobile stage 12.

In addition, the mobile stage 12 can move freely inside the scanner body 11. The four corners of the mobile stage 12 are connected to the scanner body 11 through a leaf spring 13 respectively. Thus, the mobile stage 12 can move along x-axis and y-axis in both positive and negative directions respectively. The mobile stage 12, which is moved to a certain position, can be restored to its original position by the resilience of the leaf spring 13.

The mobile stage 12 moves inside the scanner body 11 along the x-axis and y-axis in plus and minus directions. In the bottom face of the scanner body 11 are installed respectively one side of the first to fourth drivers 20 to 50, such that the mobile stage 12 can be moved in plus x direction, plus y direction, minus x direction and minus y direction respectively.

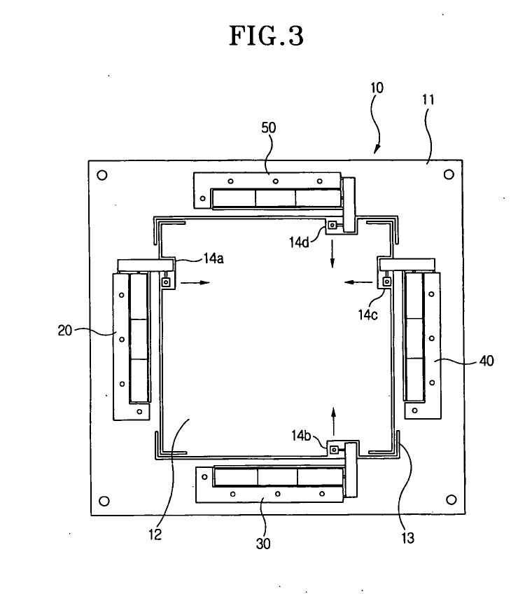

In addition, as shown in FIG. 3, the mobile stage 12 is provided with plural fixing grooves 14a to 14d formed in the bottom face thereof, to which other side of the first and fourth drivers 20 to 50 is connected so as to face thereto.

A control signal (voltage) is applied to the first and fourth drivers 20 to 50 from the controller 100. The first to fourth drivers 20 to 50 are configured such that the mobile stage 12 moves along the x, y-axis in plus or minus direction by the same distance for each driver, in response to the control signal from the controller 100. This is, a parasitic motion, which occurs in the corner area of the mobile stage 12, can be prevented. Under influence of a parasitic motion, even if a same magnitude of control voltage is applied to each of the first to fourth drivers 20 to 50, the moving distance of the mobile stage 12 by each driver is made different, due to the characteristic of each driver, i.e., the voltage-distance characteristic of each driver 20, 30, 40 and 50.

The first to fourth drivers 20 to 50 will be further detailed below.

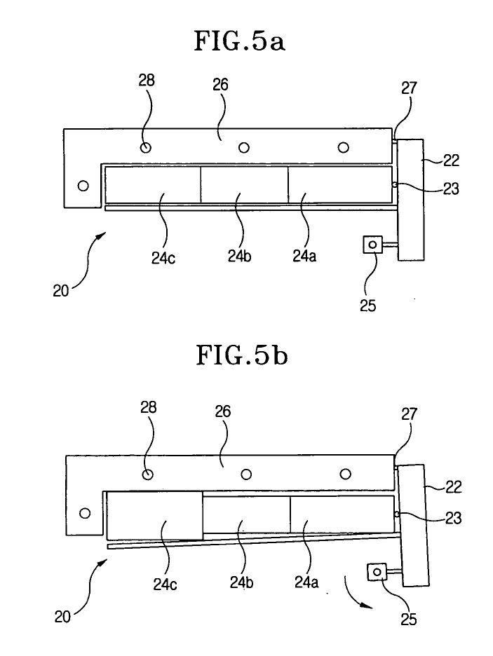

As illustrated in FIG. 5, the first driver 20 includes at least one piezo 24a, 24b, 24c, a force lever 22, a pivot point 23, a moving jig 25, a driver body 26, and a flat spring 27.

The force lever 22 is connected to the driver body 26 through the flat spring 27. In addition, to the force lever 22 is fixed a cylindrical pivot point 23, which makes a point contact with the piezo 24a, 24b, 24c. Thus, the piezo 24a, 24b, 24c is expanded in response to the control signal applied from the controller 100 and the force by the expansion is transmitted to the force lever 22 having the pivot point 23.

In addition, the force lever 22 can move a longer distance than the actual expansion distance of the piezo 24a, 24b and 24c, by means of the lever principle. That is, the force lever 22 may move in proportion to the expanded distance of the piezo 24a, 24b, 24c. For example, this embodiment is configured such that the force lever 22 can move three times of the expanded distance of the piezo 24a, 24b, 24c.

The piezo 24a, 24b, 24c is expanded or contracted by a control signal (voltage) output from the controller 100. In this way, when the piezo 24a, 24b, 24c is expanded in response to the control signal from the controller 100, it pushes one side of the force lever 22 and thus the other side of the force lever 22 is pivoted about the pivot point 23. For example, in case where the piezo is expanded 11.6 μm when 100V is applied thereto, if 100V of control signal (voltage) is applied to the first driver 20, the mobile stage 12 comes to move along x-axis or y-axis by 104.4 μm (=11.6 μm×3 (the number of piezo)×3 (the machine gain of force lever 22)).

However, the typical displacement variation of piezo 24a, 24b, 24c is approximately 2.0 μm and thus the piezo 24a, 24b, 24c is expanded within a range of 9.6˜13.6 μm.

Therefore, in the same axis drivers, for example, in the first driver 20 and the third driver 40, a driver (hereinafter, referred to as a “main driver”), which has a larger expansion of piezo, moves the mobile stage 12 up to 122.4 μm (=3×3×13.6 μm), and a driver (hereinafter, referred to as a “sub driver”), which has a smaller expansion of piezo, moves the mobile stage 12 up to 86.4 μm (=3×3×9.6 μm).

In the driver body 26 is formed a fixing hole 28, through which the driver is connected to the X-Y scanner body 11 at the bottom face thereof using a bolt (not shown), thereby fixing the piezo 24a, 24b, 24c.

The flat spring 27 connects the other end of the force lever 22 to the driver body 26. In addition, the flat spring 27 provides an elastic force such that the force lever 22 can be restored to its original position from a pivoted position when the control signal (voltage) from the controller 100 is shut off to thereby contract the piezo 24a, 24b and 24c.

One end of the position detector 60 is fixed to the X-Y scanner body 11, and the other end, which detects displacement of the mobile stage 12, is disposed on the mobile stage 12 to thereby detect the axial displacement thereof with respect to each axis.

When the mobile stage 12 is moved along the x or y axis in plus or minus direction by means of operation of the first to fourth drivers 20 to 50, the position detector 60 detects a position of the mobile stage 12, which is displaced from a reference position of the scanner body 11. The position detector 60 detects the displacement of mobile stage 12, preferably using infrared rays.

On the other hand, the bent leaf spring 13 formed between the scanner body 11 and the corners of the mobile stage 12 provides a resilient force such that the displaced mobile stage 12 can be returned into the original reference position after moved to a desired position by the first to fourth drivers 20 to 50.

In this embodiment, two position detectors 60 are provided, but three or more position detectors may be installed to thereby detect the displacement of the mobile stage 12 more precisely.

The controller 100 outputs a control signal to the first to fourth drivers 20 to 50, based on a position signal from the position detector 60 indicating a detected position of the mobile stage 12.

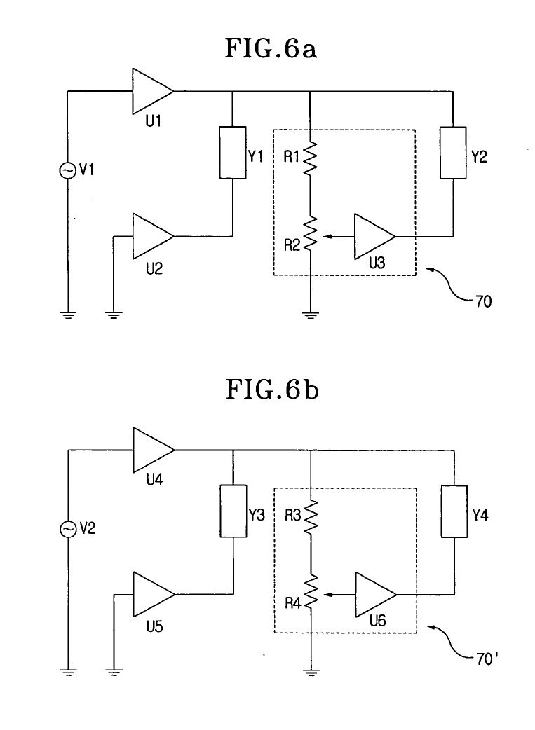

FIGS. 6a and 6b are schematic circuit diagrams showing a signal controller of the X-Y scanner in the SPM according to a first embodiment of the invention. Specifically, FIG. 6a is a schematic circuit diagram for the x-axis signal controller, and FIG. 6b is a schematic circuit diagram for the y-axis signal controller.

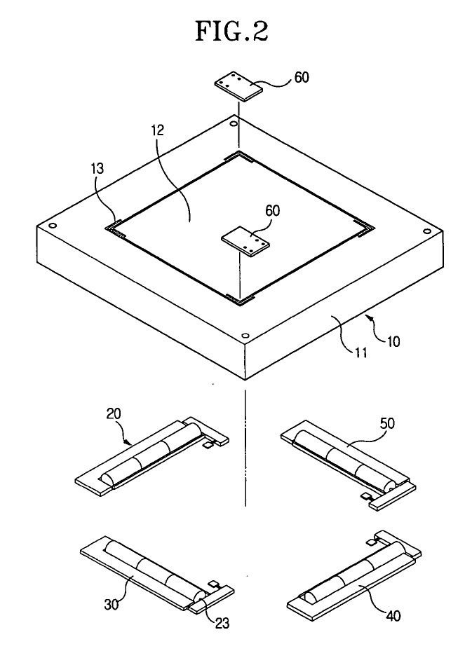

In FIG. 6a, reference numeral V1 denotes a control signal (voltage) to be applied to an x-axis sub driver Y1 and an x-axis main driver Y2. More specifically, the position detector 60 (in FIG. 2) detects the current x-axis position of the mobile stage 12 (in FIG. 2), which is displaced from an x-axis reference position, and then outputs a position signal. Based on the position signal (voltage value), the controller (hereinafter, referred to as a “voltage controller”) calculates a control signal (voltage) V1 in order to move the mobile stage to a desired position. Reference numeral 110 denotes a first voltage divider. The first voltage divider 110 compares the differences in the total displacements of the mobile stage by the x-axis main driver Y2 and the x-axis sub driver Y1 and applies a low voltage corresponding to the difference to the minus terminal of the x-axis main driver Y2.

In FIG. 6b, reference numeral V2 denotes a control signal (voltage) to be applied to an y-axis sub driver Y3 and an y-axis main driver Y4. More specifically, the position detector 60 (in FIG. 2) detects the current y-axis position of the mobile stage 12 (in FIG. 2), which is displaced from an y-axis reference position, and then outputs a position signal. Based on the position signal (voltage value), the voltage controller calculates a control signal (voltage) V1 in order to move the mobile stage to a desired position. Reference numeral 111 denotes a second voltage divider. The second voltage divider 111 compares the differences in the total displacements of the mobile stage by the y-axis main driver Y4 and the y-axis sub driver Y3 and applies a low voltage corresponding to the difference to the minus terminal of the y-axis main driver Y4.

First, referring to FIG. 6a, the voltage controller generates a control signal V1, which is amplified in an amplifier U1 and then applied to the x-axis sub driver Y1 and the x-axis main driver Y2.

Here, the voltage controller is used in order to improve the linearity of x, y-axis motion in the conventional atomic force microscope (AFM), and, in general, called a closed-loop scan. This voltage controller operates to correct improper displacement of the piezo during increase or decrease in the voltage value, and enables the piezo to be expanded linearly to the applied voltage.

In addition, the amplifier U1 is a high voltage amplifier for amplifying a control signal V1 into a 100V voltage.

The x-axis sub driver Y1 and the x-axis main driver Y2 is driven by the control signal V1 to thereby move the mobile stage 12 along the x-axis, and then the position detector 60 detects the moved x-axis position of the mobile stage 12.

By using a moved-position signals x1 and x2 of the mobile stage 12 driven by the x-axis sub driver Y1 and the x-axis main driver Y2 respectively, the voltage controller compares a representative moved-position signal (x1, or x2, or an average of x1 and x2) and the control signal V1. If the representative moved-position signal does not match the control signal V1, the voltage controller changes the x-axis control signal V1 to thereby move the mobile stage 12 to a certain intended position.

For example, it is assumed that, when a voltage of 100V is applied to the first to fourth drivers 20 to 50 (in FIG. 2), the mobile stage 12 moves 100 μm. If the control signal V1 is amplified and thus 100V of voltage is applied to the x-axis main driver Y2 and the x-axis driver Y1, the mobile stage moves approximately 103 μm by the x-axis main driver Y2 and moves approximately 98 μm by the x-axis sub driver Y1.

The first voltage divider 110 calculates a difference in the moving distances caused by the x-axis main driver Y2 and the x-axis sub driver Y2 respectively. Then, a resistance value of a variable resistor R2 of the first voltage divider 110 is found out beforehand such that a voltage corresponding the difference can be applied to the x-axis main driver Y2.

That is, according to the above assumption, the difference in the moving distances by the x-axis main driver Y2 and the x-axis sub driver Y1 is 5 μm. Thus, the first voltage divider 110 figures out a resistance value of the variable resistor R2, such that the voltage applied to both terminals of the x-axis main driver Y2 can be decreased to thereby enable the mobile stage 12 to be moved 5 μm less by the x-axis main driver Y2.

Further, the first voltage divider 110 can control the voltage applied to the x-axis main driver Y2 and the x-axis sub driver Y1 by using a well-known voltage distributing circuit or a voltage distributor.

In FIG. 6a, reference numeral U2 denotes a buffer for adjusting impedance imposed on the drivers Y1 and Y2.

In addition, referring to FIG. 6b, the voltage controller generates a control signal V2, which is amplified in an amplifier U4 and then applied to the y-axis sub driver Y3 and the y-axis main driver Y4. Here, the amplifier U4 is a high voltage amplifier for amplifying a control signal V2 to a 100V voltage.

The y-axis sub driver Y3 and the y-axis main driver Y4 is driven by the control signal V2 to thereby move the mobile stage 12 along the y-axis, and then the position detector 60 detects the moved y-axis position of the mobile stage 12.

By using moved-position signals x3 and x4 of the mobile stage 12 driven by the y-axis sub driver Y3 and the y-axis main driver Y4 respectively, the voltage controller compares a representative moved-position signal and the control signal V2. If the representative moved-position signal does not match the control signal V2, the voltage controller changes the y-axis control signal V2 to thereby move the mobile stage 12 to a certain intended position.

For example, it is assumed that, when a voltage of 100V is applied to the first to fourth drivers 20 to 50 (in FIG. 2), the mobile stage 12 moves 100 μm. If the control signal V2 is amplified and thus 100V of voltage is applied to the y-axis main driver Y4 and the y-axis driver Y3, the mobile stage moves approximately 103 μm by the y-axis main driver Y4 and moves approximately 98 μm by the y-axis sub driver Y3.

The second voltage divider 111 calculates a difference in the moving distances caused by the y-axis main driver Y4 and the y-axis sub driver Y3 respectively. Then, a resistance value of a variable resistor R4 of the second voltage divider 111 is pre-established such that a voltage corresponding the difference can be applied to the x-axis main driver Y2.

That is, according to the above assumption, the difference in the moving distances by the y-axis main driver Y4 and the y-axis sub driver Y3 is 5 μm. Thus, the second voltage divider 111 calculates and pre-establishes a resistance value of the variable resistor R4 such that the voltage applied to both terminals of the y-axis main driver Y4 can be decreased to thereby enable the mobile stage 12 to be moved 5 μm less by the y-axis main driver Y4.

Further, the second voltage divider 111 can control the voltage applied to the y-axis main driver Y4 and the y-axis sub driver Y3 by using the well-known voltage distributing circuit or the voltage distributor.

In FIG. 6b, reference numeral U5 denotes a buffer for adjusting impedance imposed on the drivers Y3 and Y4.

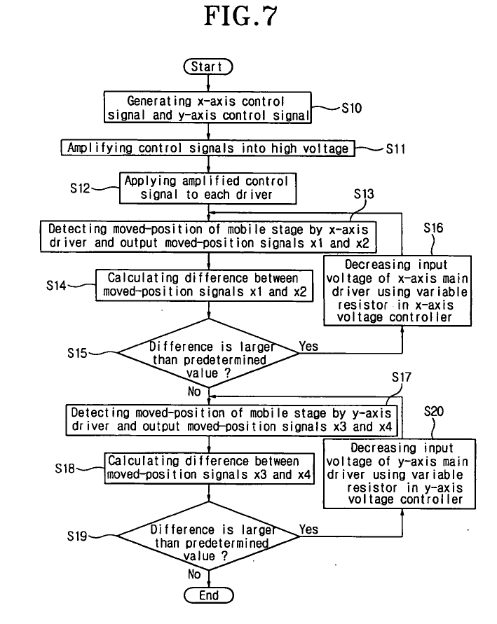

FIG. 7 is a flow chart explaining the control of a driver voltage using a variable resistor in the X-Y scanner according to the first embodiment of the invention.

In FIG. 7, the voltage controller generates an x-axis control signal V1 and an y-axis control signal V2 (S10), and the amplifier U1, U4 (in FIGS. 6a and 6b) amplifies the control signals V1 and V2 into a high voltage (S11).

At step S12, the amplified control signal is applied to each driver. At step S13, the position detector 60 detects the position of the mobile stage 12 (in FIG. 2), which is moved by the x-axis drivers Y1 and Y2 (in FIG. 6a), and outputs moved-position signals x1 and x2 (S13).

At step S14, the voltage controller calculates the difference between the moved-position signals x1 and x2 and determines whether or not the difference is larger than a certain predetermined value (S15).

At the step S15, if the difference between the moved-position signals x1 and x2 is larger than the predetermined value, the voltage controller changes the resistance value of the variable resistor R2 in the first voltage divider 110 and the corresponding voltage is applied to the minus terminal of the x-axis main driver Y2 (S16). Accordingly, the voltage to be applied to the x-axis main driver Y2 is decreased.

At the step S15, if the difference is not larger than the desired value, the position detector 60 detects the position of the mobile stage 12 (in FIG. 2), which is moved by the y-axis drivers Y3 and Y4 (in FIG. 6a), and outputs a moved-position signals x3 and x4 (S17).

At step S18, the voltage controller calculates the difference between the moved-position signals x3 and x4 and determines whether or not the difference is larger than a certain predetermined value (S19).

At the step S19, if the difference between the moved-position signals x3 and x4 is larger than the predetermined value, the voltage controller changes the resistance value of the variable resistor R4 in the second voltage divider 111 and the corresponding voltage is applied to the minus terminal of the y-axis main driver Y4 (S20). Accordingly, the voltage to be applied to the y-axis main driver Y4 is decreased.

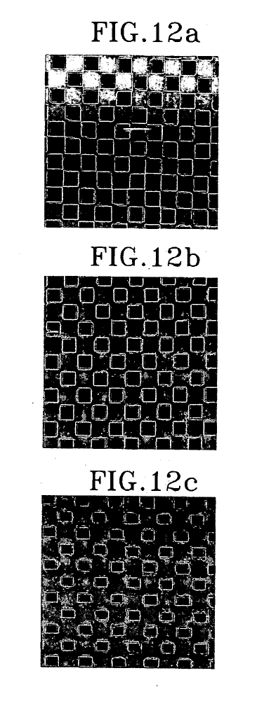

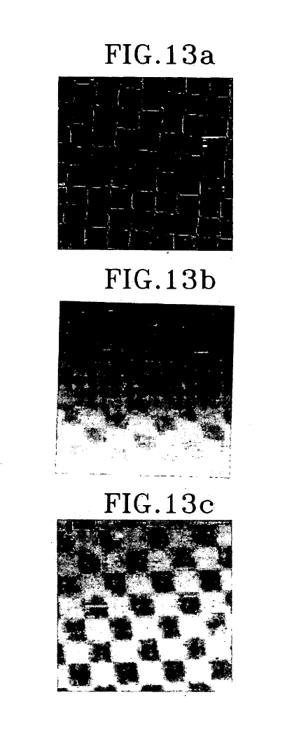

According to this embodiment as described above, it has been found that an image having perpendicularity can be obtained, as shown in FIGS. 12a to 12c.

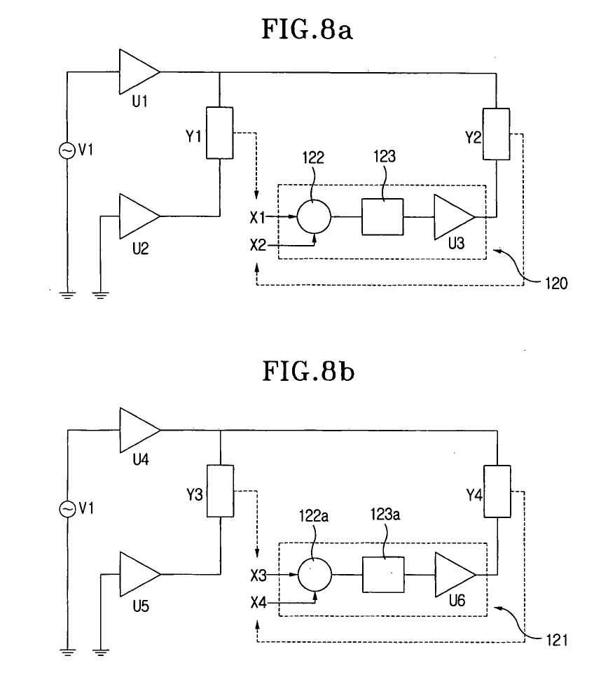

FIGS. 8a and 8b are a schematic circuit diagram showing a local feedback unit of the X-Y scanner in the SPM according to a second embodiment of the invention. Specifically, FIG. 8a is a schematic circuit diagram of an x-axis local feedback unit, and FIG. 8b is a schematic circuit diagram of an y-axis local feedback unit. In FIGS. 8a and 8b, the same elements as in the first embodiment of FIGS. 6a and 6b are denoted by the same reference numerals, and details thereon will not be repeated here.

In FIG. 8a, reference numeral 120 denotes a first local feedback controller, which compares the moving distances of the mobile stage 12 by the x-axis main driver Y2 and the x-axis sub driver Y1, and apply a differential signal (voltage), corresponding to the difference in the moving distances, to the minus terminal of the x-axis main driver Y2.

In addition, in FIG. 8b, reference numeral 121 denotes a second feedback controller. The second feed back controller 121 functions to compare the moving distances of the mobile stage 12 by the y-axis main driver Y4 and the y-axis sub driver Y3, and apply a differential signal (voltage), which corresponds to the difference in the moving distances, to the minus terminal of the y-axis main driver Y4.

First, referring to FIG. 8a, the control signal V1 generated from the voltage controller is amplified in the amplifier U1 and then applied to the x-axis sub driver Y1 and the x-axis main driver Y2. Here, the amplifier is a high voltage amplifier for amplifying the control signal V1 to a voltage of 100 V.

According to the control signal V1, the x-axis sub driver Y1 and the x-axis main driver Y2 is driven to move the mobile stage 12 along the x-axis. Then, the voltage controller detects a moved-position signals x1, x2 of the mobile stage 12 respectively caused by the x-axis sub driver Y1 and main driver Y2, using the position detector 60. In the first local feedback controller 120, a position difference calculator 122 calculates a difference between the moved-position signals x1 and x2 and transforms into a desired differential signal (voltage) through an x-axis transfer function 123. The differential signal (voltage) is amplified through an amplifier U6 and applied to the x-axis main driver Y2. Here, the transfer function 123 may employ a proportional-integral-derivative (PID) mode.

Therefore, the first local feedback controller 120 is operated at certain regular intervals of time or frequency in the above-described manner, such that each of the x-axis main driver Y2 and the x-axis sub driver Y1 can move the mobile stage 12 by a same quantity of distance. At this time, the voltage applied to the x-axis main driver Y2 may be calculated from the following equation 1:

$${V}_{x 1} = {\sum }_{t = 0}^{n} {a}^{i} {V}_{s}^{i} \qquad [ Equation 1 ]$$

Here, Vm is a voltage in a driver having a longer moving distance, n is a correction index, a is a value between 0.9 and 1, and Vs is a voltage in a driver having a shorter moving distance.

For example, it is assumed that, when a voltage of 100V is applied to the first to fourth drivers 20 to 50, the mobile stage 12 moves 100 μm and a scanning is performed at the unit of 100 μm. If the control signal V1 is amplified and thus 100V of voltage is applied to the x-axis main driver Y2 and the x-axis driver Y1, the mobile stage moves approximately 103 μm by the x-axis main driver Y2 and moves approximately 98 μm by the x-axis sub driver Y1. In the first local feedback controller 120, the x-axis position difference calculator 122 calculates the difference in the moving distances of the mobile stage 12 driven by the x-axis main driver Y2 and the x-axis sub driver Y1. In this case, the distance difference is 5 μm.

The x-axis transfer function 123 generates a differential signal (voltage) corresponding to the above 5 μm, which is amplified in the amplifier U3 and then applied to the minus terminal of the x-axis main driver Y2.

Thereafter, the x-axis main driver Y2 moves the mobile stage 12 by 31 μm in the opposite direction along the x-axis such that the moving distance of the mobile stage 12 by the x-axis main driver Y2 becomes eventually to 100 μm. As the x-axis main driver Y2 operates in this manner, the mobile stage 12 moves 0.5 μm by the x-axis sub driver Y1 and eventually the moving distance by the x-axis sub driver Y1 becomes to 98.5 μm.

The first local feedback controller 120 is operated at certain regular intervals of time or frequency in the above-described manner, such that each of the x-axis main driver Y2 and the x-axis sub driver Y1 can move the mobile stage 12 by a same quantity of distance, i.e., 99 μm.

Therefore, the voltage controller increases the control signal (voltage) applied to the x-axis main driver Y2 and the x-axis sub driver Y1, in order to move the mobile stage 12 by a distance of 100 μm. In addition, as described above, the first local feedback controller 120 is operated at certain regular intervals of time or frequency, thereby moving the mobile stage 12 by a distance of 100 μm.

Furthermore, referring to FIG. 8b, the y-axis main driver Y4 and the y-axis sub driver Y3 moves the mobile stage 12 by a same quantity of distance, in the similar manner as in FIG. 8a.

That is, the control signal V2 generated in the voltage controller is amplified using an amplifier U4 and then applied to the y-axis sub driver Y3 and the y-axis main driver Y4.

The y-axis sub driver Y3 and the y-axis main driver Y4 are driven by the control signal V2 to thereby move the mobile stage 12 along the y-axis, and then the position detector 60 detects the y-axis moved-position of the mobile stage 12.

Then, the voltage controller detects a moved-position signal x3 of the mobile stage 12 driven by the y-axis sub driver Y3 and a moved-position signal x4 driven by the y-axis main driver Y4.

In the second local feedback controller 121, a y-axis position difference calculator 122a calculates a difference between the moved-position signals x3 and x4 and transforms into a desired differential signal (voltage) through a y-axis transfer function 123a. The differential signal (voltage) is amplified through an amplifier U6 and applied to the y-axis main driver Y4.

Therefore, as described above, the second local feedback controller 121 is operated to feedback at certain regular intervals of time or frequency, such that each of the y-axis main driver Y4 and the y-axis sub driver Y3 can move the mobile stage 12 by a same quantity of distance.

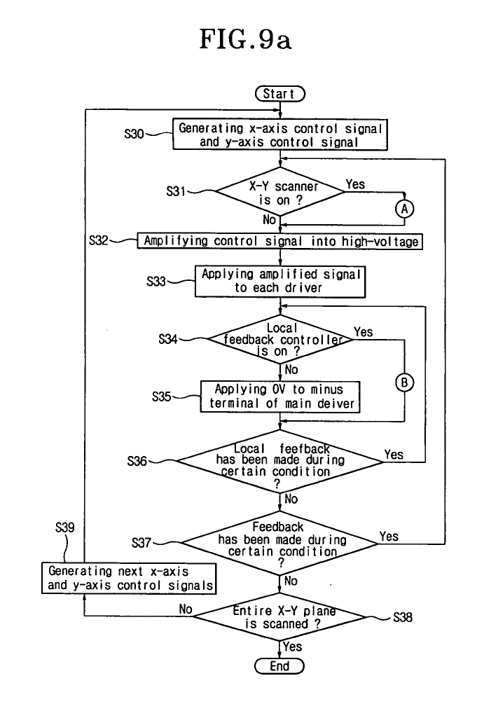

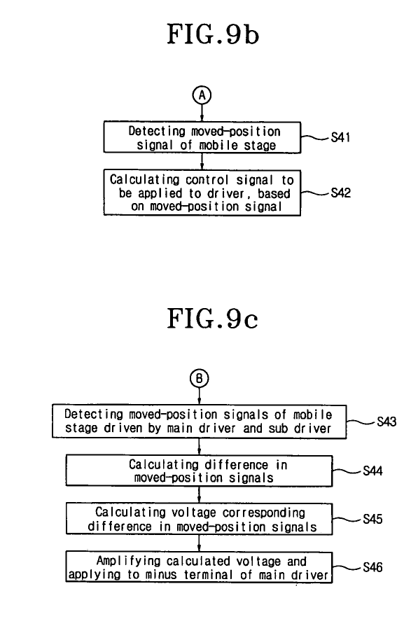

FIG. 9a is a flow chart explaining the operation of the local feedback unit in the second embodiment of the invention shown in FIGS. 8a and 8b. FIG. 9b is a detailed flow chart of the portion A in FIG. 9a and FIG. 9c is s detailed flow chart of the portion B in FIG. 9a.

Referring to FIG. 9a, first, the voltage controller generates an x-axis control signal V1 and an y-axis control signal V2 (S30), and determines whether the X-Y scanner is on or off (S31).

At step S31, if the X-Y scanner is on, the portion A of FIG. 9b is executed. That is, at step S41, the position detector 60 detects a moved-position of the mobile stage, and, at step S42, a control signal to be applied to the driver is calculated, based on the detected moved-position signal.

At step S32, the generated control signals are amplified to a high voltage, and at step S33, the amplified signals are applied to the respective drivers to thereby drive each driver.

Then, the local feedback controller is determined as to whether it is on or off (S33). If the local feedback controller is on, the portion B of FIG. 9c is executed. That is, at step S43, moved-position signals of the mobile stage 12 driven by the main driver and the sub driver are detected, and a step S44, a difference between the detected moved-position signals is calculated. At step S45, a differential signal (voltage), which corresponds to the difference in the moved-position signals, is calculated, and at step S46, the calculated differential signal (voltage) is amplified and applied to the minus terminal of the sub driver.

At step S34, if the local feedback controller is on, a voltage of 0V is applied to the minus terminal of the sub driver (S35).

At step S36, the voltage controller determines whether or not the first and second local feedback controllers 120 and 121 have made a feedback during a certain predetermined condition (for example, time or frequency).

At step S36, if the feedback controllers did not make any local feedback during the predetermined condition, the operation is returned to the step S34 and continues a local feedback. If the feedback controllers made a local feedback, the voltage controller is determined as to whether it made a feedback during a certain predetermined condition (for example, time or frequency).

At step S37, if a feedback is not performed during the predetermined condition, the operation is returned to the step S31 and continues the scanning. If a feedback is made, the voltage controller determines whether the entire X-Y plane has been scanned (S38).

At step S38, if the entire X-Y plane is not scanned, the voltage controller generates a next x-axis control signal and a next y-axis control signal.

According to this embodiment as described above, it has been found that an image having perpendicularity can be obtained, as shown in FIGS. 12a to 12c.

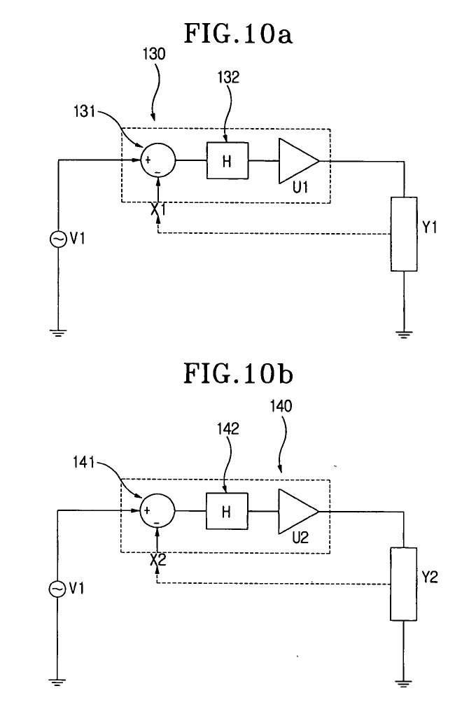

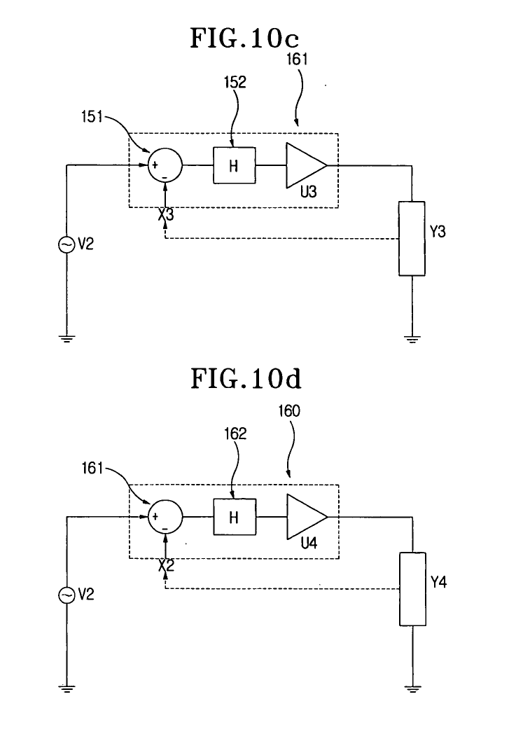

FIGS. 10a to 10d are a schematic circuit diagram showing a local feedback unit of the X-Y scanner in the SPM according to a third embodiment of the invention. Specifically, FIG. 10a is a schematic circuit diagram of an x-axis feedback unit for the x-axis sub driver, FIG. 10b is a schematic circuit diagram of an x-axis feedback unit for the x-axis main driver, FIG. 10c is a schematic circuit diagram of a y-axis feedback unit for the y-axis sub driver, and FIG. 10d is a schematic circuit diagram of a y-axis feedback unit for the y-axis main driver.

In FIGS. 10a to 10d, the same elements as in previous embodiments are denoted by the same reference numerals and detains thereon will not be repeated here.

In FIG. 10a, reference numeral 130 denotes an x-axis feedback unit of x-axis sub driver, which compares the moving distances of the mobile stage 12 driven by the x-axis sub driver Y1 and applies a differential signal (voltage), corresponding to a difference in the moving distances, to both terminals of the x-axis sub driver Y1.

In FIG. 10b, reference numeral 140 denotes an x-axis feedback unit of x-axis main driver, which compares the moving distances of the mobile stage 12 driven by the x-axis main driver Y2 and applies a differential signal (voltage), corresponding to a difference in the moving distances, to both terminals of the x-axis sub driver Y2.

In FIG. 10c, reference numeral 150 denotes a y-axis feedback unit of y-axis sub driver, which compares the moving distances of the mobile stage 12 driven by the y-axis sub driver Y3 and applies a differential signal (voltage), corresponding to a difference in the moving distances, to both terminals of the y-axis sub driver Y3.

In FIG. 10d, reference numeral 160 denotes a y-axis feedback unit of y-axis main driver, which compares the moving distances of the mobile stage 12 driven by the y-axis main driver Y4 and applies a differential signal (voltage), corresponding to a difference in the moving distances, to both terminals of the y-axis main driver Y4.

First, referring to FIG. 10a, the control signal V1 generated from the voltage controller is amplified in an amplifier U1 and then applied to the x-axis sub driver Y1. Here, the amplifier U1 is a high voltage amplifier for amplifying the control signal V1 into 100V voltage.

According to the control signal V1, the x-axis sub driver Y1 moves the mobile stage 12 along the x-axis and then the voltage controller detects a moved-position signal x1 of mobile stage driven by the x-axis sub driver Y1, using the position detector 60.

In the x-axis feedback unit 130 of x-axis sub driver, a position difference calculator 131 calculates a difference between the control signal V1 and the moved-position signal x1 and the calculated difference is transformed into a desired differential signal (voltage) through an x-axis transfer function 132. The differential signal is amplified and applied to the x-axis sub driver Y1. Here, the transfer function 123 may employ a proportional-integral-derivative (PID) mode.

Therefore, the voltage controller carries out a feedback during a certain predetermined condition (for example, time or frequency) through the above course of operations, to thereby move the mobile stage 12 in an identical and consistent manner.

For example, it is assumed that, when a voltage of 100V is applied to the first to fourth drivers 20 to 50, the mobile stage 12 moves 100 μm and a scanning is performed at the unit of 100 μm. If the control signal V1 is amplified and thus 100V of voltage is applied to the x-axis sub driver Y1, the mobile stage moves approximately 98 μm by the x-axis sub driver Y1.

In the x-axis feedback unit 130 for x-axis sub driver, then the x-axis position difference calculator 131 calculates the difference in the moving distances of the mobile stage 12 driven by the x-axis sub driver Y1. In this case, the distance difference is 2 μm.

The x-axis transfer function 132 generates a differential signal (voltage), which corresponds to the distance difference. The differential signal is amplified using the amplifier U1 and then applied to both terminals of the x-axis sub driver Y1.

The voltage controller performs the above feedback operation during a certain condition (for example, time or frequency) to thereby move the mobile stage 12 in a constant distance of 100 μm.

In addition, referring to FIG. 10b, the mobile stage 12 can be moved in the same manner as in FIG. 10a.

The control signal V1 generated from the voltage controller is amplified in an amplifier U2 and then applied to the x-axis main driver Y2. Here, the amplifier U2 is a high voltage amplifier for amplifying the control signal V1 into 100V voltage.

According to the control signal V1, the x-axis main driver Y2 moves the mobile stage 12 along the x-axis and then the voltage controller detects a moved-position signal x2 of mobile stage driven by the x-axis main driver Y2, using the position detector 60.

In the x-axis feedback unit 140 of x-axis main driver, a position difference calculator 141 calculates a difference between the control signal V1 and the moved-position signal x2 and the calculated difference is transformed into a desired differential signal (voltage) through an x-axis transfer function 142. The differential signal is amplified and applied to the x-axis sub driver Y1.

Therefore, the voltage controller carries out a feedback during a certain predetermined condition (for example, time or frequency) through the above course of operations, to thereby move the mobile stage 12 in an identical and consistent manner.

The y-axis sub driver Y3 in FIG. 10c and the y-axis main driver Y4 in FIG. 10d can be operated in the same manner as in FIGS. 10a and 10b to thereby move the mobile stage in an identical and consistent manner, i.e., in a same quantity of distance for every instance.

This embodiment is configured such that the control signals applied to the drivers Y1 to Y4 can be controlled in a parallel manner.

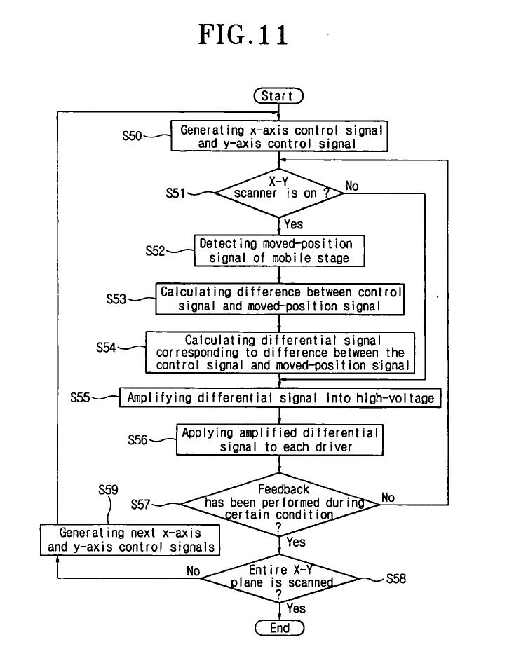

FIG. 11 is flow chart explaining the operation of the feedback unit in FIGS. 10a to 10d.

Referring to FIG. 11, the voltage controller generates an x-axis control signal V1 and an y-axis control signal V2 (S50), and determines whether the X-Y scanner is on or off (S51).

At step S51, if the X-Y scanner is on, the voltage controller detects a moved-position signal of the mobile stage 12 (S52) and calculates a difference between the generated control signal and the moved-position signal of the mobile stage (S53).

The voltage controller calculates a differential signal (voltage), which corresponds to the difference between the control signal and the moved-position signal of the mobile stage (S54). The differential signal is amplified into a high voltage using an amplifier (S55).

At the step S51, if the X-Y scanner is off, the control signal generated in the step S50 is amplified into a high voltage (S55).

At step S56, the amplified differential signal (voltage) is applied to each driver.

At step S57, the voltage controller determines whether a feedback is performed during a certain condition (for example, time or frequency). If a feedback is not carried out during the condition, the operation is returned to the step S51.

At the step S57, if a feedback is performed during the predetermined condition, the voltage controller determines if the entire X-Y plane is scanned (S58).

At the step S58, if the whole X-Y plane is not scanned, the voltage controller generates a next x-axis control signal and a next y-axis control signal (S59).

According to this embodiment as described above, it has been found that an image having perpendicularity can be obtained, as shown in FIGS. 12a to 12c.

As described above, according to the invention, two drivers having different voltage-distance characteristics are installed on each axis in parallel to each other, and different voltages are applied to the two drivers such that the mobile stage can be moved by a same quantity of distance every time by the two drivers. Therefore, a parasitic motion such as rotation or tilting can be avoided from the scanner movement, and a clear image having perpendicularity can be obtained from the entire area of a large sample such as a silicon wafer, using a scanning probe microscope of the invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An apparatus for driving an X-Y scanner in a scanning probe microscope, the apparatus comprising:
(a) one or more position detector for detecting a moved-position of a mobile stage and generating a moved-position signal, the mobile stage capable of holding a specimen and moving along at least one of x-axis and y-axis from a reference position;
(b) a controller for generating a plurality of control signals based on the moved-position signal from the position detector, such that the mobile stage is moved along at least one of x-axis and y-axis by a certain desired quantity of distance; and
(c) a plurality of drivers for moving the mobile stage along at least one of x-axis and y-axis, in response to the control signals from the controller.

2. The apparatus according to claim 1, wherein the driver includes a first driver for moving the mobile stage along the positive direction of x-axis; a second driver for moving the mobile stage along the negative direction of x-axis; a third driver for moving the mobile stage along the positive direction of y-axis; and a fourth driver for moving the mobile stage along the negative direction of y-axis.

3. The apparatus according to claim 2, wherein the driver comprises: a piezo expanding and contracting in response to the control signal from the controller; a pivot point making a point contact with the piezo; a force lever pivoting about the pivot point according to the expansion and contraction of the piezo; a spring for restoring the pivoted force lever to the original position thereof; and a driving jig for moving the mobile stage when the force lever is pivoted.

4. The apparatus according to claim 1, wherein the controller comprises: a voltage controller for detecting a current-position of mobile stage moved from the reference position using the moved-position signal from the position detector, and calculating a desired voltage value from the current-position voltage value such that the mobile stage can be moved to a desired position; and a voltage divider for dividing a voltage to be applied to each driver, according to the calculated voltage value from the voltage controller.

5. The apparatus according to claim 4, wherein the voltage controller is configured such that, if the mobile stage is moved in a same quantity of distance in response to the control signal applied to each driver, the moving of mobile stage is ended.

6. The apparatus according to claim 4, wherein the voltage divider is a voltage distributor or a variable resistor.

7. The apparatus according to claim 1, wherein the controller comprises: a local feedback controller for detecting a current-position of mobile stage moved from the reference position using the moved-position signal from the position detector, and calculating a compensation value from the detected current-position such that the mobile stage can be moved to a desired position; and a voltage divider for dividing a voltage to be applied to each driver, according to the calculated compensation value from the local feedback controller.

8. The apparatus according to claim 7, wherein the voltage divider is a voltage distributor or a variable resistor.

9. The apparatus according to claim 1, wherein the controller comprises: a feedback controller for detecting a current-position of mobile stage moved from the reference position using the moved-position signal from the position detector, and calculating either a voltage value for the current-position voltage value or a compensation value from the detected current-position, or both of them, such that the mobile stage can be moved to a desired position; and a voltage divider for dividing a voltage to be applied to each driver, according to at least of the calculated voltage value and the calculated compensation value from the feedback controller.

10. The apparatus according to claim 9, wherein the voltage divider is a voltage distributor or a variable resistor.

11. A method of driving an X-Y scanner in a scanning probe microscope, the method comprising steps of:
(a) outputting a control signal for controlling a plurality of drivers such that a mobile stage can be moved along an x- and y-axis;
(b) detecting a current-position signal of the mobile stage using a position detector for detecting a position of mobile stage;
(c) analyzing the current-position signal from the position detector and determining whether the mobile stage is moved by a same quantity of distance from a reference position of each axis to a desired position along the positive or negative direction thereof; and
(d) controlling as to whether or not each driver is to be operated, depending on the determination.

12. The method according to claim 11, in the step (c), if the mobile stage is not moved the same quantity of distance by the plurality of the driver, further comprising a step of: dividing a voltage such that a control signal of a driver which has moved the mobile stage a longer distance can be decreased, and a control signal of a driver which has moved the mobile stage a shorter distance can be increased.

13. The method according to claim 12, wherein the control signal applied to the driver includes a voltage.

14. The method according to claim 11, in the step (c), if the mobile stage is not moved the same quantity of distance by the plurality of the driver, further comprising a step of: applying a control signal such that the mobile stage can be moved from a reference position along the same axis to a desired position sequentially.

15. The method according to claim 14, wherein, in the control signal applying step, the control signal is obtained in accordance with the following equation.
$${V}_{x 1} = {\sum }_{t = 0}^{n} {a}^{i} {V}_{s}^{i}$$
Here, Vm is a voltage in a driver having a longer moving distance, n is a correction index, a is a value between 0.9 and 1, and Vs is a voltage in a driver having a shorter moving distance.
